(19) United States
(12) Patent Application Publication
(10) Pub. No.: US 2006/0165100 A1
(43) Pub. Date: Jul. 27, 2006

(54) Wireless location privacy

(76) Inventors: Leping Huang, Tokyo (JP); Kauta Matsuura, Tokyo (JP); Hiroshi Yamane, Tokyo (JP); Kaoru Sezaki, Tokyo (JP)

Correspondence Address: ROBERT M BAUER, ESQ.;LACKENBACH SIEGEL, LLP, 1 CHASE ROAD, SCARSDALE, NY, 10583, US

(21) Appl. No.: 11/254,981

(22) Filed: Oct. 20, 2005

(30) Foreign Application Priority Data
Oct. 22, 2004 (GB) 0423529.7

(51) Int. Cl. H04L 12/66

(52) U.S. Cl. 370/400; 370/328; 370/352

(57) ABSTRACT

A method for combating the tracking of a mobile transceiver, the mobile transceiver forming a node in a wireless communication network which has at least one other node, the method comprising the steps for enabling, until a first time, the transmission of a radio packet that depends upon a first anonymous address; calculating, dependent on a privacy level for the mobile transceiver, a second time; enabling, from the second time, the transmission of a radio packet that depends upon a second anonymous address; and disabling, between the first time and the second time, the transmission of a radio packet that depends upon either the first anonymous address or the second anonymous address.

### RELATED APPLICATION

This application claims priority to UK Patent Application No. 0423529.7, filed Oct. 22, 2004, which is incorporated herein by reference in its entirety.

### BACKGROUND OF THE INVENTION

The present invention relates to a method for combating tracking of a mobile transceiver.

Recent technological advances in wireless location-tracking present unprecedented opportunities for monitoring the movements of individuals. While such technology can support many useful location-based services (LBSs), which tailor their functionality to a user's current location, privacy concerns might seriously hamper user acceptance.

There are currently several efforts researching methods to protect users' location privacy when conducting wireless transmission. The main idea of those approaches is to protect location privacy by periodically updating the nodes' MAC address. However, current solutions may not prevent nodes from being tracked as locating technology improves and nodes can be more accurately located. Under such high precision tracking system, new attacking methods using the correlation between old and new MAC address can defeat periodical address update methods. Examples of such problems and possible solutions are given below.

According to the current Bluetooth Specification (version 1.1), Bluetooth devices, when in discoverable mode, always reply to inquiry requests with a FHS packet that identifies the unique 48-bit Bluetooth device address of the device.

If a malicious user has access to a widely deployed Bluetooth Access Pont network, he can track the positions of all Bluetooth devices by repeatedly sending inquiry requests and collecting the FHS packets sent in reply. As each FHS packet received in reply contains a device's permanent and unique Bluetooth address, the malicious user can track, from the received replies, individual devices as they move.

A malicious user may alternatively intercept (sniff) all Bluetooth packets sent over the air.

### DESCRIPTION OF THE INVENTION

To prevent position tracking, there is a current proposal to enhance the current Bluetooth specification by including an ‘anonymity mode’. The details of this proposal are not yet public. However, in anonymity mode, a node uses a randomly generated Bluetooth address BD_ADDR (an anonymous address) instead of the permanent and unique Bluetooth address. Location tracking is combated by regularly updating the anonymous address.

According to the ‘anonymity mode’ proposal each Bluetooth device has a unique 48-bit Bluetooth device address (BD_ADDR_fixed). The address includes a lower address part (LAP) of 24 bits, an upper address part (UAP) of 8 bits and a non-significant address part of 16 bits. Each device also has a 48-bit Bluetooth active device address (BD_ADDR), which has the same format as BD_ADDR_fixed.

For non-anonymous devices or for devices that do not support anonymity mode, the BD_ADDR equals BD_ADDR_fixed and is not updated.

For devices in anonymous mode, the LAP of the BD_ADDR is pseudo-random and is updated frequently. The updating depends upon two parameters: the address update period (T_{ADDR}_{_{—}}_{update}) and the reserved period for inquiry (T_{ADDR}_{_{—}}_{inquiry period}). A timer t1 is used to trigger address updates and is re-started when a new BD_ADDR has been generated. A timer t2 is started whenever a BD_ADDR is sent in a FHS packet, such as in an inquiry response, master page response or master-slave role switch. The timer t2 prevents an address update for a critical period after sending an FHS packet.

While t1≦T_{ADDR}_{_{—}}_{update} or t2≦T_{ADDR}_{_{—}}_{inquiry period}, then the BD_ADDR is not updated. However, whenever t1>T_{ADDR}_{_{—}}_{update} and t2<T_{ADDR}_{_{—}}_{inquiry period} the process for updating BD_ADDR is started.

The value of T_{ADDR}_{_{—}}_{update} can range between 1 second and 194 days, but has a default value of 24 hours. The value of T_{ADDR}_{_{—}}_{inquiry period} can range between 30 and 255 seconds, but has a default value of 60 seconds. Thus, if the default values are used, the anonymous address is updated approximately every 24 hours.

If an updated address BD_ADDR is generated by a Master, all connected devices in the piconet that support anonymity mode are informed of the updated address BD_ADDR and of a future time at which the Master will start to use the updated address.

The BD_ADDR of a device is used to define a hopping sequence, the channel access code (CAC) and device access code (DAC) for the device. A change in the BD_ADDR changes the DAC and hopping sequence used to transmit a FHS packet in response an inquiry request. A change in the BD_ADDR of a Master changes the CAC and hopping sequence used to transmit packets within the piconet controlled by the Master.

The periodic updating of the anonymous address is intended to prevent location tracking.

However, the inventor has realized that the currently proposed anonymity mode may not necessarily prevent location tracking.

The proposal becomes inefficient at combating location tracking of a Bluetooth device when there is a low density of surrounding Bluetooth devices, when the Bluetooth device moves very slowly and when the position of the Bluetooth device can be very accurately determined.

Although the current proposal for anonymity mode may be sufficient for current Bluetooth based positioning technology that has a resolution of 1 m, the inventor has realized that as location technology improves and Bluetooth devices can be accurately located then the current proposal for ‘anonymity mode’ may not prevent Bluetooth devices being tracked. This is because, as a device can be positioned accurately it will be possible to find a strong correlation between a trail left by an old anonymous address and that left by a new anonymous address. The old and new anonymous addresses can therefore be linked. Such correlation becomes easier as the distance between Bluetooth devices increase, the speed of a device decreases and the accuracy with which a device can be positioned increases.

### DESCRIPTION OF THE DRAWINGS

FIG. 1 illustrates a piconet 10 that comprises a plurality of Bluetooth-enabled radio transceiver devices 2. Some of the devices 2 may be mobile. Each device communicates using packets transmitted over a radio communication range of approximately 10 m.

The transceiver devices 2 of the piconet 10 comprise a Master M and a plurality of Slaves S1, S2, S3 and S4. The Master M controls the piconet 10. The timing of the piconet is based upon the timing of the Master M. The frequency-hopping sequence used by the network is based upon the BD_ADDR of the Master and the packets sent within the piconet have as their synchronization word an Access Code derived from the BD_ADDR of the Master M.

FIG. 2A illustrates the movement of two mobiles transceiver devices 2A and 2B. The transceiver device 2A changes its anonymous address at each point 12 along its path. The new address may be immediately obtained by initiating an Inquiry request or by sniffing communications by the transceiver device 2A.

The transceiver device 2B changes its anonymous address at each of the points 14 along its path. The new address may be immediately obtained by initiating an Inquiry request or by sniffing communications by the transceiver device 2A.

It may be possible to associate a first anonymous address received from a transceiver device when at position P1 with a second anonymous address previously received from a transceiver device when at position P2 with the same transceiver device because of temporal and/or spatial correlation. Temporal correlation may be used because the period with which transceiver devices change their anonymous addresses may be fixed but different. Spatial correlation may be used if it is assumed that transceiver devices will generally continue in the same direction with the same speed as they traveled in the past.

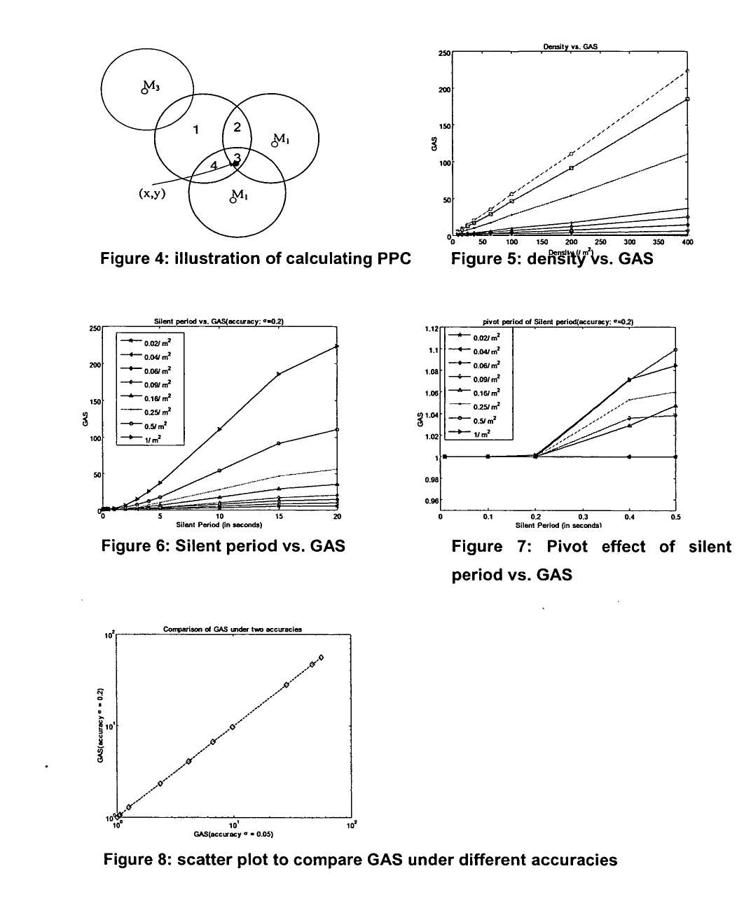

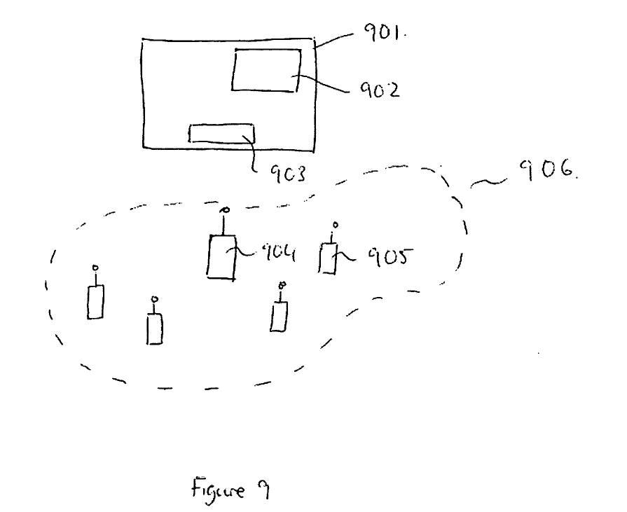

FIG. 2B illustrates the movement of two mobile transceiver devices 2A and 2B.

The first mobile transceiver 2A enables, until a first time 11, the transmission of a radio packet that depends upon a first anonymous address BD_ADDR(1). The first mobile transceiver 2A enables, from a second time 16, the transmission of a radio packet that depends upon a second anonymous address BD_ADDR(2). The first mobile transceiver 2A disables for a transitional silence period 18, between the first time 11 and the second time 16, the transmission of all radio packets that depend on either the first anonymous address BD_ADDR(1) or the second anonymous address BD_ADDR(2).

Although, transmissions are limited between the first time and the second time, it is still possible to transmit radio packets that do not identify the first transceiver device because they depend on neither the first anonymous address nor the second anonymous address. This will only be possible if the transceiver device is operating as a Slave.

The transceiver device 2A changes its anonymous address at each point 12 along its path. However, for the sake of clarity the effect is only illustrated near the intersection of the paths of both transceiver devices. The silence period 18 is illustrated by a break in the path of the device 2A. The silence period begins at the first time 11 and ends at a second time 16.

Likewise the second mobile transceiver 2B enables, until a third time 15, the transmission of a radio packet that depends upon a third anonymous address BD ADDR(3). The second mobile transceiver 2B enables, from a fourth time 17, the transmission of a radio packet that depends upon a fourth anonymous address BD_ADDR(4). The first mobile transceiver 2A disables for a transitional silence period 19, between the third time 15 and the fourth time 17, the transmission of all radio packets that depend on either the third anonymous address BD_ADDR(3) or the fourth anonymous address BD_ADDR(4).

Although, transmissions are limited between the third time and the fourth time, it is still possible to transmit radio packets that cannot identify the transceiver device because they depend on neither the third anonymous address nor the second anonymous address. This will only be possible if the transceiver device is operating as a Slave.

The transceiver device 2B changes its anonymous address at each point 12 along its path. However, for the sake of clarity the effect is only illustrated near the intersection of the paths of both transceiver devices. The silence period 19 is illustrated by a break in the path of the device 2B. The silence period begins at the first time 15 and ends at a second time 17.

The silent transitional periods introduce ambiguity into any determination of the time and/or place at which a change of anonymous address occurred. This makes it more difficult to associate two separately received anonymous addresses with the same transceiver device because the silence periods disrupt temporal and/or spatial correlation.

A transmission of a radio packet may depend upon an anonymous address when:
a) it includes the anonymous address
b) it includes a synchronization word based upon the anonymous address such a Common Access Code (CAC) or Device Access Code (DAC).
c) it uses a frequency from a frequency-hopping-sequence based upon the anonymous address, for example when an FHS packet is sent by a Slave.
d) it is a L2CAP link establishment packet

Thus disabling during the silent transitional period may prevent:
(i) the transmission of FHS packets between the first time and the second time
(ii) the mobile transceiver performing an inquiry scan or replying to an inquiry request between the first time and the second time
(iii) the mobile transceiver performing a page scan or replying to a page request between the first time and the second time
   Synchronized Network

The first transceiver device 2A and the second transceiver device 2B of FIG. 2B may be time synchronized to a common time reference. The first time and the third time correspond to the same first common time, and the second time and the fourth time correspond to the same second common time.

The time duration between the first common time and the second common time is adjustable. The adjustment is preferably automatic and may be dependent upon:
a) a measure of the separation of the mobile transceivers
b) a measure of the accuracy with which a mobile transceiver can be located
c) a measure of the speed with which a mobile transceiver moves

Each of these measures may be user configurable. The user may either enter a value for the measure or select a pre-defined measure.

The measure of the separation of the plurality of the mobile transceivers may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The time duration T between the first common time and the second common time, is such that T≧(d−4* e)/2v, where d is a minimum separation in meters between the transceiver device and its neighboring transceiver devices, e is the error in meters associated with the technology used for locating the transceiver device and v is the average rectilinear velocity of the transceiver device. A pedestrian typically moves with a velocity of 6 km/h, whereas a car may move with a velocity of 60 km/h.

Unsynchronized Network

The first transceiver device 2A and the second transceiver device 2B of FIG. 2B may not be time synchronized. Each transceiver device has its own local time reference. In this case the first time and the third time are independent and the second time and the fourth time are independent.

The difference between the first (local) time and the second (local) time may comprise a calculated minimum period and an independent, randomly generated period.

The minimum period is calculated in dependence upon:
a) a measure of the separation between the first mobile transceiver 2A and its neighboring mobile transceivers
b) a measure of the accuracy with which the first mobile transceiver 2A can be located
c) a measure of the speed with which the first mobile transceiver 2A moves

Each of these measures may be user configurable. The user may either enter a value for the measure or select a pre-defined measure.

The measure of the separation may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The minimum period T1, is such that T1≧(d−4* e)/2v, where d is an average separation in meters between the first transceiver device 2A and its neighboring transceiver devices, e is the error in meters associated with the technology used for locating the first transceiver device 2A and v is the average rectilinear velocity of the first transceiver device 2A.

The value of T_{ADDR}_{_{—}}_{update}, that is the frequency with which anonymous address of the first transceiver device 2A is changed, may also be automatically adjustable. The adjustment may dependent upon:
a) a measure of the separation between the first mobile transceiver 2A and its neighboring mobile transceivers
b) a measure of the accuracy with which the first mobile transceiver 2A can be located
c) a measure of the speed with which the first mobile transceiver 2A moves

Each of these measures may be user configurable. The user may either enter a value for the measure or select a pre-defined measure.

The measure of the separation may be obtained automatically from one or more inquiry requests, which will identify the number of radio transceiver devices that are within communication range.

The measure of the accuracy with which a mobile transceiver can be located may be remotely configurable by, for example, a data download. It will also depend upon the technology used for location e.g. triangulation, GPS etc.

The difference between third (local) time and the fourth (local) time also comprises a calculated minimum period and an independent, randomly generated period.

The minimum period is calculated in dependence upon:
a) a measure of the separation between the second mobile transceiver 2B and its neighboring mobile transceivers
b) a measure of the accuracy with which the second mobile transceiver 2B can be located
c) a measure of the speed with which the second mobile transceiver 2B moves

Each of these measures may be user configurable. The user may either enter a value for the measure or select a pre-defined measure.

The minimum period T1, is such that T1≧(d−4*e)/2v, where d is an average separation in meters between the second transceiver device 2B and its neighboring transceiver devices, e is the error in meters associated with the technology used for locating the second transceiver device 2B and v is the average rectilinear velocity of the second transceiver device 2B.

The value of T_{ADDR}_{_{—}}_{update}, that is the frequency with which anonymous address of the second transceiver device 2B is changed, may also be automatically adjustable. The adjustment may dependent upon:
a) a measure of the separation between the second mobile transceiver 2B and its neighboring mobile transceivers
b) a measure of the accuracy with which the second mobile transceiver 2B can be located
c) a measure of the speed with which the second mobile transceiver 2B moves

FIG. 3 illustrates an example of a typical Bluetooth enabled radio transceiver device 30. The transceiver device 30 comprises a processor 32, a radio transceiver 34, a clock 36, a memory 38 and a user interface 40, which includes a display 42 and a keypad 44 for user input. It should be appreciated that this illustration is only a schematic.

The processor 32 is connected to each of the radio transceiver 34, clock 36, memory 38 and user interface 40.

The processor uses the clock 36 to maintain a timer t, which is used to control the silent transitional period 18, 19.

The memory 38 stores computer program instructions, which when loaded into the processor 32 enable it to perform the methods described above.

The transceiver device 30 may park the Slaves in the piconet if the silent transitional period will exceed the Link_Supervision timeout period i.e. the maximum period for which there can be no communication on a link without it being assumed that the link has been lost.

Although the above examples have been described in relation to a Bluetooth low power radio frequency network, they may be used in other radio networks where it is desirable to combat the tracking of devices and/or users, for example, to mobile cellular telecommunication networks.

Through our previous research, we noticed that there is a quantitative measure missing in the latest location privacy protection researches. Current algorithms realize their effectiveness of location privacy protection with the cost of service degradation and/or out-of-service period. In other words, there is a tradeoff between service quality and privacy level a system can provide. Because current research lacks a quantitative measure for wireless location privacy level, the system designer cannot determine the parameters of those algorithms based on users' privacy and service quality needs. Consequently, this restricts the feasibility of many location privacy protection algorithms.

There are many important privacy related works in the anonymous communication research area. Several quantitative measures are also used in these proposals. From these, the size of the anonymity set defined by Chaum (David Chaum, “The Dining Cryptographers Problem: Unconditional Sender and Recipient Untraceability”, J. Cryptol., vol. 1, pp. 65-75, 1988) is one of the most widely used to measure the anonymity of the Dining Cryptographer's (DC) network. The anonymity set is defined as the set of participants who may have sent a particular message, as seen by a global observer that also compromises a set of nodes. Recently, Serjantov et al. (Andrei Serjantov and George Danezis: “Towards an Information Theoretic Metric for Anonymity”, Proceedings of the Workshop on Privacy Enhancing Technologies (PET) 2002, LNCS 2482, 41-53, Springer-Verlag, 2003) and Diaz et al. (Claudia Díaz, Stefaan Seys, Joris Claessens, and Bart Preneel: “Towards Measuring Anonymity”, Proceedings of the Workshop on Privacy Enhancing Technologies (PET) 2002, LNCS 2482, 54-68, Springer-Verlag, 2003) have independently proposed an information theoretic model to measure the degree of anonymity of such a system. These papers identify that not all nodes involved in anonymous communication contribute same degree of anonymity to the system. The size of anonymity set cannot precisely describe the degree of anonymity a system provides. These papers therefore take into account the probability of a user sending and/or receiving a message and propose the use of entropy of all users' probabilities of sending and/or receiving message as the measure of anonymous system.

Current location privacy protection algorithms lack a general quantitative measure. This problem causes difficulties in evaluating the feasibility of proposals and in implementing the algorithm in real systems. Therefore, there is a need to fill in this missing part in current location privacy protection research

Embodiments of the present invention introduce a new measure called the geographical anonymity set (GAS) to fill in the missing part in the location privacy protection area. The proposed measure can be used to evaluate most of the location privacy protection methods that are based on periodical address updates. The GAS measure is evaluated using the “silent period” method of location privacy protection described above.

According to a first embodiment of the present invention, there is provided a method for combating the tracking of a mobile transceiver, the mobile transceiver forming a node in a wireless communication network which has at least one other node, the method comprising the steps of enabling, until a first time, the transmission of a radio packet that depends upon a first anonymous address, calculating, dependent on a privacy level for the mobile transceiver, a second time, enabling, from the second time, the transmission of a radio packet that depends upon a second anonymous address and disabling, between the first time and the second time, the transmission of a radio packet that depends upon either the first anonymous address or the second anonymous address.

Preferably, the second time is after the first time.

Preferably, the mobile transceiver has a unique identity in the wireless communication network and the first anonymous address and second anonymous address are independent of that identity.

The method may further comprise the steps of: randomly generating at least a portion of the first anonymous address before enabling the transmission of a radio packet that depends upon the first anonymous address and randomly generating at least a portion of the second anonymous address before enabling the transmission of a radio packet that depends upon the second anonymous address.

Preferably, the step of disabling comprises disabling between the first time and the second time, the transmission of all radio packets that depend on either the first anonymous address or the second anonymous address.

Typically, a radio packet depends upon an anonymous address when it includes the anonymous address. Alternatively, transmission of a radio packet may depend upon an anonymous address when it includes a synchronization word based upon the anonymous address, when it uses a frequency from a frequency-hopping-sequence based upon the anonymous address or when it is a L2CAP link establishment packet.

The step of disabling may prevent the transmission of FHS packets between the first time and the second time, may prevent the mobile transceiver replying to an inquiry request between the first time and the second time or may prevent the mobile transceiver replying to a page request between the first time and the second time.

The method may further comprise transmitting, between the first time and the second time, radio packets that depend on neither the first anonymous address nor the second anonymous address.

Preferably, at least one other node is also arranged to perform the method for combating tracking.

The privacy level for the mobile transceiver may be dependent on the spatial location of the at least one other node with respect to the spatial location of the mobile transceiver and/or the first time and the second time for the at least one other node with respect to the first time and the second time for the mobile transceiver.

The first time and second time for the mobile transceiver may be different from the first time and second time for the at least one other node.

Preferably, the privacy level for the mobile transceiver is the Geographical Anonymity Set (GAS) of the mobile transceiver, which may be calculated the privacy level of the mobile transceiver in accordance with equations 1 to 5 below. The result for equation 2 may be calculated according to the pseudo code in table 3.

The method may further comprise calculating the privacy level of the mobile transceiver using the following: the Position Privacy Contribution (PPC), the Node Privacy Level (NPL) and the System Privacy Level (SPC).

The second time may be calculated dependent on a desired privacy level for the mobile transceiver. The second time may be calculated dependent on a desired privacy level for the mobile transceiver and a desired privacy level for at least one other node with which the mobile transceiver is communicating.

Preferably, the second time is calculated by the steps of: determining the number of nodes located in an area of known size surrounding the mobile transceiver and in which the mobile transceiver is located; assessing the contribution that each of these nodes makes to a privacy level of the mobile transceiver; and determining a duration of a silent period for which transmission by the node of a packet depending on an anonymous address is to be disabled in dependence on the assessed contribution and a desired privacy level of the mobile transceiver.

The method may further comprise the step of calculating a node density from the determined number of nodes and the area of known size.

The step of assessing the contribution that each of the surrounding nodes makes to a privacy level of the mobile transceiver may comprise estimating a relationship between the privacy level and the duration of the silent period at the calculated node density. The network element may determine the duration of the silent period by selecting the duration that according to the relationship corresponds to a privacy level equal to the desired privacy level.

According to a second embodiment of the present invention, there is provided a network element capable of operating in a wireless communication network and of communicating with at least one node in the network, the network element being arranged to combat tracking of a wireless transceiver that forms one of the nodes by the steps of: determining the number of nodes located in an area of known size surrounding the mobile transceiver and in which the mobile transceiver is located; assessing the contribution that each of these nodes makes to a privacy level of the mobile transceiver; and determining a duration of a silent period for which transmission by the node of a packet depending on an anonymous address is to be disabled in dependence on the assessed contribution and a desired privacy level of the mobile transceiver.

Preferably the network element is arranged to calculate a node density from the determined number of nodes and the area of known size.

The network element may be arranged to assess the contribution that each of the surrounding nodes makes to a privacy level of the mobile transceiver by estimating a relationship between the privacy level and the duration of the silent period at the calculated node density. Alternatively, the network element may be arranged to assess the contribution that each of the surrounding nodes makes to a privacy level of the mobile transceiver by accessing a known relationship between the privacy level and the duration of the silent period at the calculated node density. The network element may be arranged to access the known relationship from a memory contained within the network element or from a memory external to the network element.

Preferably the network element determines the duration of the silent period by selecting the duration that according to the relationship corresponds to a privacy level equal to the desired privacy level.

According to a third embodiment of the invention, there is provided a communication system comprising at least one node, the nodes being capable of communicating with each other via the communication system, and the communication system being arranged to combat tracking of a mobile transceiver that forms one of the nodes by the steps of: enabling, until a first time, the transmission of a radio packet that depends upon a first anonymous address; calculating, dependent on a privacy level for the mobile transceiver, a second time; enabling, from the second time, the transmission of a radio packet that depends upon a second anonymous address; and disabling, between the first time and the second time, the transmission of a radio packet that depends upon either the first anonymous address or the second anonymous address.

For a better understanding of the present invention and to understand how it may be brought into effect, reference will now be made by way of example only to the accompanying drawings in which:

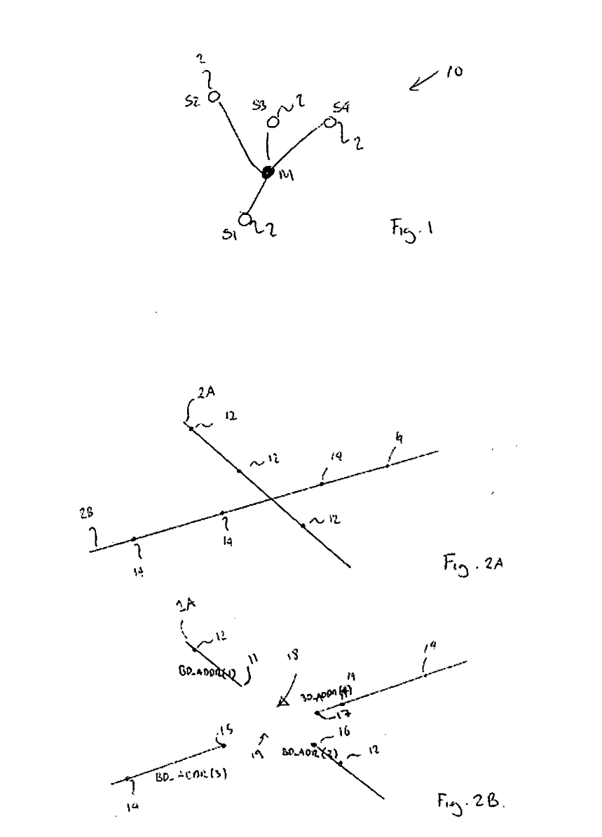

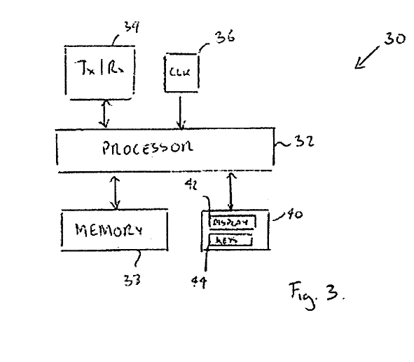

FIG. 1 illustrates a piconet that comprises a plurality of Bluetooth-enabled radio transceiver devices;

FIG. 2A illustrates the movement of two mobiles transceiver devices 2A and 2B which do not use the invention;

FIG. 2B illustrates the movement of two mobiles transceiver devices 2A and 2B which use one embodiment of the invention;

FIG. 3 illustrates a radio transceiver device;

FIG. 4 illustrates calculating a Position Privacy Contribution function (PPC);

FIG. 5 illustrates a plot of Geographical Anonymity Set (GAS) against density;

FIG. 6 illustrates a plot of GAS against silent period;

FIG. 7 illustrates a plot of GAS against silent period showing the pivot effect of silent period;

FIG. 8 illustrates a scatter plot comparing GAS for different accuracies; and

FIG. 9 illustrates an example of a communication system for implementing a method of combating tracking of a mobile transceiver.

A solution to combat the correlation attack in high location tracking system was described above (see also e.g. Leping Huang, Kaoru Sezaki: “An Assessment of Wireless Location Privacy Risks in High Precision Positioning System”, Technical report on ISEC TG of IEICE, June, 2004). This solution is known as the “silent period” approach. The silent period is defined as a transition period between using new and old pseudonyms in which a station is not allowed to disclose either the old or the new pseudonym. As a result, the silent period introduces ambiguity into the determinations of the time and/or place at which a change of anonymous address occurred. This makes it more difficult to associate two separately received pseudonyms with the same station, because the silent period disrupts the temporal and/or spatial correlation between two separately received pseudonyms and obscures the time and place where a pseudonym changed. One silent period should contain one constant period and one variable period. The effect of the constant period is to mix the spatial relation between a node's disappearing points and its emerging points, while the effect of the variable period is to mix the temporal relation between the node's disappearing times and its emerging times.

There are several factors that may influence the performance of the silent period approach. They are (1) the duration of the silent period, (2) the accuracy of the positioning system, (3) the mobility model of the individuals, (4) the density of users, and (5) the timing of address updates (i.e. whether or not the updates are synchronized or unsynchronized). In principle, longer silent periods and/or a higher density of individuals will improve privacy levels, as will more random movement of individuals. More accurate positioning systems cause lower privacy levels, as do unsynchronized pseudonym switches.

The quantitative measure provided by embodiments of the invention will now be described.

First, all nodes involved in the location-information protection system are classified into two types, target and mixer. A target is defined as a node whose privacy system is measuring. All other nodes involved in the system are defined as mixers. Mixers contribute to the privacy of target by restricting frame transmission for silent period of time and thereby obscuring the temporal and spatial relation between their and the target's pseudonyms. The role of mixer and target may change depending on which object the tracking system monitors.

In a location privacy protection system, not all mixers contribute the same level of privacy to the target. The number of mixers that participate in the system cannot precisely quantify the degree of privacy. Only those mixers, whose geographical reachable area overlaps with that of target, and whose emerging time overlaps with that of the target, contribute a certain level of privacy to the target node. The contribution depends on the distribution of the mixers' and target's destinations after the silent period and the temporal relation between the address update time of the target and that of the mixers. As a result, the quantitative measure should take into account the difference in contribution caused by the spatial distribution of the nodes' destinations and the temporal relation of the node's emerging times.

An example is shown in FIG. 4. The circle around each node denotes the area reachable by that node during the silent period. The reachable area of the target is divided into four areas. When the target arrives at somewhere within area 3, the mixers contribute to the privacy level of the target when and only when they arrive at areas 2, 3, and 4.

To calculate the target's privacy level involves first calculating the privacy level that the mixers contribute if the target arrives at a given point. Then, the privacy level of the target is deduced by the expectation of privacy level at all reachable points for the target. We define PC_{x,y,t} as the discrete random variable of privacy contribution at position (x,y) and time t. The values of PC_{x,y,t} vary within a range of {α₁, α₂, . . . , αᵢ, . . . }. Each value of privacy contribution αᵢ is decided by the number of mixers that satisfy following requirements:

Privacy Contribution Requirement

(1) (x,y) is within the reachable area of that mixer after t seconds.

(2) Mixer arrives at an area that is reachable for target.

(3) Mixer's emerging time overlaps with that of target.

We define one-variable function pc_{x,y,t}(i) as the probability mass function of PC_{x,y,t}. For a given position (x,y) and silent period t, Each value i of pc_{x,y,t}(i) represents the probability by which i mixer nodes satisfy the three requirements above. In addition, we also define a continuous random variable Qₜ, which represents the distribution of the target's destination after t seconds. Three variable functions q(x,y,t) are defined as the probability distribution function of Qₜ over a two dimensional geographical area.

Before calculating the expected privacy level of target node, we first compute the expected privacy level at any given position. Here we define a new terminology position privacy contribution PPCₙ(x,y,t) as the contribution of privacy by all mixers of target n at position (x,y) after t seconds.

Definition 1: Position Privacy Contribution PPCₙ(x,y,t)

$${PPC}_{n} ( x , y , t ) = \vert {PC}_{x , y , t} \vert = {\sum }_{i = 0}^{N} {α}_{i} {pc}_{x , y , t} ( i ) \qquad ( 1 )$$

PPCₙ(x,y,t) is the expected value of discrete random variable PC_{x,y,t} at position (x,y) and time t for all possible conditions that mixers contribute their privacy level.

We give a pseudo code about how to calculate PPC in table 3. In this algorithm, we first find out relative mixers, and then calculates the overlapping probability P_{c,y,t}.

Definition 2: Node Privacy Level NPL(t,n)

Node n's Privacy level is contributed to by node n's mixers.

From its definition, NPL is the expectation of Qₜ over all reachable area of target. The value of Qₜ at each position (x,y) are given by PPCₙ(x,y,t). Consequently, NPL can be given as below.
NPL(t,n)=∫∫q(x,y,t,n)PPCₙ(x,y,t)dxdy (2)

Definition 3: System Privacy Level SPL(t)

The average position privacy level that all nodes in the location protection system receive.

$$\begin{matrix}SPL ( t ) = \frac{1}{N} {\sum }_{n = 1}^{N} NPL ( t , n ) \\ = \frac{1}{N} {\sum }_{n = 1}^{N} \int \int q ( x , y , t , n ) {PPC}_{n} ( x , y , t ) ⅆ x ⅆ y\end{matrix} \qquad ( 3 )$$

In the equations above, we only define that the value of privacy contribution αᵢ is related to number of arrived nodes. Here, privacy contribution αᵢ is considered to be one measure of the geographical anonymity set (GAS). GAS is proposed to measure the degree of anonymity of a set in a location privacy protection system. GAS can be seen as an extension of a traditional metric of an anonymous system, the size of an anonymity set. The anonymity set of a system is defined as the set of all possible subjects that may be involved in an anonymous communication. Many previous researches use the size of the anonymity set as a metric of the system. As discussed above, such a metric is not suitable for measuring location privacy in a large area, because the nodes contribute different levels of privacy to their neighbors based on their overlapping probability. However, we think that the size of anonymity set is still effective when the area is small enough and the emerging time of the nodes overlaps with that of the target. If there are i mixers that satisfy the privacy contribution requirements when target arrives at area [(x, x+dx), (y,y+dy)], the anonymity set when node at this area is (i+1) according to traditional anonymous research. Consequently, the value of privacy contribution αᵢ is assigned as the number of nodes including target arrived at this area simultaneously as below.
αᵢ=(i+1). (4)

Therefore, the geographical anonymity set of a node is given in Eq.(5) below:

$$GAS ( t , n ) = \int \int q ( x , y , t , n ) ( {\sum }_{i = 0}^{N} ( i + 1 ) {pc}_{x , y , t} ( i ) ) ⅆ x ⅆ y \qquad ( 5 )$$

When the address update times of all the mixers is not synchronized with that of target, some nodes that arrive at the reachable area of target may not contribute to target's privacy level. This decreases the privacy level of target nodes. The overlapping probability is determined by the ratio between the address update time and the silent period and underlying protection methods.

Equation 5 is determined by both the spatial probability of the distribution of the mixers and the target's destination and the temporal relation of address update timing between the target and the mixers. This gives us a more precise description about the location privacy a system provides, compared with the number of nodes involved in the location protection system.

Based on the proposed measure GAS, we evaluated the performance of our previous “silent period” proposal by simulation to study the impact of (1) duration of silent period, (2) node density, and (3) measurement accuracy on node privacy level.

In our simulation, we put one target and some mixer nodes in a 2D rectangle area. All the nodes first moved for a given period of time to avoid initial position bias. Then, the mixers and target moved for a “silent period” of time to calculate node privacy level given in Equation 2. We assumed that tracking accuracy followed a Gaussian distribution with an average of the accurate node position and a variable parameter σ. In this simulation, we assume that all nodes switch their address simultaneously. Other parameters used in simulation are listed in table 1 below.

TABLE 1
Simulation Configuration

| Mobility model | Random walk, |
|---|---|
| | Speed model 2 ∈ (0.1 m/s) |
| | Period of address update: 1000 seconds |
| Simulation | 20 m * 20 m |
| Area size | |
| Init position of | Uniformly distributed within simulation area |
| mixer node | |
| Node density | 0.02/m², 0.5/m² |
| Silent period | 1 ms to 20 seconds |
| Accuracy (σ) | 0.05, 0.1, 0.2, 0.3 |

FIG. 5 shows the change in GAS when the node density changes from 0.02/m², to 1/m². Different lines in the figure indicate the trend for a given length of silent period.

FIG. 6 illustrates the trend of GAS variation when the silent period changes from 1 ms to 20 seconds. From this figure, we perceive that the value of GAS is proportional to the length of silent period. When silent period increases, the growth ratio of GAS decreases. The decrease in GAS growth ratio may be due to the mobility model that was used. In the random walk mobility model, the node tends to return to its start point when the silent period increases.

The relation between the silent period and GAS when silent period is small is illustrated in FIG. 7. This figure clearly shows that GAS keeps stable when silent period is smaller than 0.2 seconds, and begins to increases after that point under different density conditions. Such “pivot effects” show that when the interval between new and old MAC addresses is too small, the silent period has no effect at all. This gives the minimum value of the silent period.

A simulation to show the effect of accuracy on GAS was also conducted. As the pseudo code shows in table 3, the destination of each mixer after the silent period was collected N times and these N samples were used to calculate PPC. In the simulation, N was 10K. FIG. 8 depicts the relationship between GAS taken at two different accuracies (σ=0.05 m and σ=0.3 m). We estimated that finer accuracy should results in lower GAS. However, FIG. 8 seems to show that GAS is independent of accuracy because of the large number of samples. In other words, using a large number of samples removes the effect of estimation error due to limited accuracy.

In summary, an increase in density improves system privacy and GAS is independent of accuracy when the number of tracking sample is large. There is a “pivot effect” in the relation between silent period and GAS. When the silent period is smaller than some threshold, it has no effect at all on the node's privacy level. When the silent period is larger than the threshold, it is generally proportional to GAS, but the growth ratio of GAS decreases when the silent period becomes large due to the characteristics of the underlying mobility model.

To conclude the introduction of the new quantitative measure, a measure “Geographical Anonymity Set” can be used for wireless location privacy. GAS is based on the anonymity set metric used in mix-net and takes into account the probabilities that users contribute to each other's privacy level due to their geographical location and mobility model. The previous “silent period” proposal has been evaluated using GAS, which presented the relationship between node density, tracking system accuracy and length of silent period. Simulation results show that density is proportional to GAS, while accuracy does not affect GAS when the tracking system can get enough tracking samples. There is a “pivot effect” in the relation between GAS and the silent period. In the simulation, the tracking system was able to get a large enough number of samples about the nodes' start and end points. This removed the effect of accuracy on privacy level.

The above quantitative measure can be used to improve the location privacy that can be offered to users of a wireless communication system by setting the length of the “silent period” according to a desired privacy level of a node. It can be seen from the above simulation results that an increased length of silent period generally results in increased privacy due to an increased probability that nodes will contribute to each other's privacy. However, from a practical viewpoint, it is desirable for the length of the silent period to be as short as possible, because transmissions are necessarily limited during the silent period in order to prevent a malicious user from tracking a device in the system. For example, as explained above, disabling transmissions including an anonymous address during a silent period may prevent the following:
(i) the transmission of FHS packets between the first time and the second time
(ii) the mobile transceiver performing an inquiry scan or replying to an inquiry request between the first time and the second time
(iii) the mobile transceiver performing a page scan or replying to a page request between the first time and the second time.

Therefore, a balance needs to be achieved between the desirability of having a high level of privacy and the undesirability of limiting transmissions for any significant length of time.

The method of analysing a node's privacy level that previously described can be usefully employed in setting the length of the “silent period”. For example, if a node has a desired privacy level that is known by the system, the system can calculate the silent period necessary to achieve that desired privacy level by measuring the GAS of the system and comparing this with a desired privacy level for the node. In this way, the length of silent period may be tailored to the current privacy conditions in the system. This avoids the silent period being unnecessarily long when a high density of surrounding nodes provides an inherently high degree of privacy. Similarly, the privacy level can be maintained when the surrounding node density is low by increasing the length of the silent period.

One method of measuring the GAS of a node in a system is explained above. This method may be practically implemented by a base station or similar of the communication system, e.g. such as a master of a Bluetooth network. By determining the node density surrounding a target node and by using a graph such as that illustrated in FIG. 6, a base station can select an appropriate silent period for a desired privacy level. For example, using FIG. 6 as an example, the curve corresponding to the calculated node density should be used to read off the silent period corresponding to the desired privacy level. If the calculated node density is not represented by any of the curves shown in FIG. 6, then the correct silent period may be calculated by interpolation. Similarly, it may be that the base station has only a selection of discrete time periods available to it and that none of these time periods correspond to that read off the curve, In this case, the shortest of the available time periods that results in a privacy level at least equal to the desired privacy level should be selected.

As explained above with reference to FIG. 7, when the silent period is very small it has no effect on the privacy of a node. The “pivot” point shown in FIG. 7 sets the minimum silent period and so the silent period must always be longer than this minimum duration.

In order to determine the appropriate silent period the base station needs to know the current node density. The base station may perform a location update procedure to discover how many nodes are in the same area as the target node. Alternatively, the base station may already know how many nodes are in that area. The area considered by the base station may be the entire area covered by the base station, or may be a subset of that area, depending on how large a geographical area the base station covers. The chosen area may also depend on the current location of the target node. Some locations covered by the base station may have an impact of the privacy contribution made by neighbouring nodes. For example, if the target node is located near a wall, hill or similar obstruction it may be appropriate to only consider the node density on the same side of the obstruction as the target node. It is important that the size of the selected area is known to the base station, so that the node density may be calculated simply by dividing the number of nodes by the known size.

The base station may use known data from a simulation that was carried out previously to determine the appropriate silent period, for example, a graph such as FIG. 6. Alternatively, the base station itself may perform the necessary calculations, e.g. by using a simulation as explained above. If known data is used, it could be stored e.g. in memory contained within the base station, or it could made available to the base station over a network.

The advantage of performing the simulations in the base station is that the correct node density may be used so that interpolation is not required. Also, the required variables may be set according to the current conditions in the communication system. For example, for the variables listed in table 1 the base station could input values for speed, period of address update, initial position of mixer nodes and accuracy using the known situation in the system at the time. For example, the base station may use a location update procedure to estimate the initial location and speed of the mixer nodes. The disadvantage of such an approach that computational resources and time are required to perform a simulation each time a target's silent period is to be updated. Therefore, the viability of this approach may depend on the frequency with which a node's silent period is updated and also the sensitivity of the simulation results to factors such as the initial position of the mixers etc. If the simulation is relatively insensitive to the exact value of such parameters then the extra computational resources and time required to perform a simulation for each silent period update are unlikely to be justified.

If the base station does not perform the simulations but has access to the results of previous simulations, the base station preferably has available to it the results of simulations carried out under many different conditions. For example, if the period of address update varies between nodes, it would be beneficial for the base station to have access to different sets of simulation results corresponding to different lengths of address update periods. Different simulation results need only be provided where variation in a condition has an appreciable effect on the variation of privacy with node density.

However the simulation results are obtained, it is preferable a large number of samples to be obtained about the start and end points of the nodes because, as explained above, this removes the effect of accuracy on the estimated privacy level.

In addition to an estimation of privacy level, the determination of a suitable silent period may also include a consideration of the parameters mentioned above, such as:
a) a measure of the separation of the mobile transceivers;
b) a measure of the accuracy with which a mobile transceiver can be located; and
c) a measure of the speed with which a mobile transceiver moves.

The silent periods or desired privacy levels of any adjacent nodes may also be considered.

As nodes typically move within a wireless communication system, the silent period to be used by each node should be updated on a regular basis. The frequency with which updates are performed may be set for a particular node. For example, the update frequency may be selected by the user or may be determined according to the desired privacy level. For example, if the desired privacy level is high, the silent period updates may be performed more frequently. Alternatively, the frequency of the updates may be varied according to how desirable an update is perceived to be by the base station. For example, if the base station monitors the node density surrounding the target node on a regular basis, it may perform an update whenever the node density changes appreciably. An update may also be triggered by the node itself, and could be triggered by the user.

When a silent update has been triggered, the base station communicates the new silent period to the node, which accordingly modifies the period for which certain transmissions are prevented.

The desired privacy level may be set by the user or may be predetermined for a particular node.

A straightforward implementation of a communication system according to an embodiment of the invention is shown in FIG. 9. The communication system includes a base station 901 capable of communicating via transceiver 903 with mobile nodes 904, 905. The base station includes a privacy unit 902 that is capable of accessing privacy information and using that information to determine a suitable silent period for a target node 904 by taking into account the privacy contribution of the mixer nodes 904 in the area 906 occupied by the target node. The calculated silent period may be communicated to the target node by transceiver 903. The privacy unit may have an integral memory for storing privacy information or may be connected to a separate unit, which stores the desired information.

Equally, embodiments of the invention may be implemented in a piconet such as that illustrated in FIG. 1. In this implementation, a master node M controls a plurality of slave nodes S1 to S4. According to one embodiment, the master node determines the appropriate silent period and informs the slave nodes accordingly. Alternatively, a slave node determines the appropriate silent period it should be using. The slave node might determine the density of nodes in its surrounding area by e.g. listening to surrounding Bluetooth transmissions.

Although the above explanation refers to a base station, it should be understood that the method of the invention is not limited to being implemented in any particular network element.

Although embodiments of the invention have been described in the preceding paragraphs with reference to various examples, it should be appreciated that various modification may be made thereto without departing from the spirit and scope of the invention. For example, although the invention has been described in relation to a Bluetooth low power radio frequency network, it may be used in other radio networks where it is desirable to combat the tracking of devices and/or users. Thus the invention may be applied, for example, to mobile cellular telecommunication networks. In particular, the present invention is applicable to WLAN networks.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

TABLE 2
Notations and Terminology

| | |
|---|---|
| GAS | Geographical anonymity set |
| TA | Tracking accuracy |
| Target | Node whose privacy is being measured |
| Mixer node | Nodes (excluding the target) that participate in the location privacy protection |
| | system |
| PC_{x,y,t} | Discrete random variable, which represents the privacy contribution at |
| | position (x, y) and time t, and whose range of values is {α1, α2, . . . αI, . . . } |
| Qₜ | Continuous random variable, which represents the target's destination |
| | distribution after t seconds. |
| αᵢ | Value of the privacy contribution, which depends only on the number of nodes |
| | arriving simultaneously with the target at same location |
| pc_{x,y,t}(i) | Probability that i mixer nodes satisfy privacy contribution requirements. |
| q(x, y, t, n) | Probability distribution function of Qt within two dimensional space for a |
| | given node n after t seconds |
| PPCₙ(x, y, t) | Point privacy contribution at position (x, y) after t seconds |
| NPL(t, n) | Node privacy level of node n after t seconds |
| SPL(t) | System privacy level after t seconds |
| T1 | Address lifetime |
| T2 | Silent period, which varies between [T2min, T2max], with a range of Δ_{T2}. |
| σ | The standard deviation of Gaussian distribution used to describe accuracy |
| | model |

TABLE 3
Pseudo codes for Equation 2

```
Definition:
{Mi}: set of mixers
{RMi}: set of relative mixers
T: Target
R(X): reachable area of node X
Dt(X): Destination of node X after t seconds
N: number of tries to get the destination of mixer
C: Counter
Function calculate_ppc(x,y) {
  Foreach Mi {
    if (x,y) is within R(Mi), add Mi to {RMi}
  }
  loop N times {
      Foreach {RMi} {
        If D(RMi) is within R(T)
              C=C+1;
  }
  Add C to pcx,y,t(i);
  C=0;
    }
}
```

1. A method for combating the tracking of a mobile transceiver, the mobile transceiver forming a node in a wireless communication network which has at least one other node, the method comprising the steps of:
enabling, until a first time, the transmission of a radio packet that depends upon a first anonymous address;
calculating, dependent on a privacy level for the mobile transceiver, a second time;
enabling, from the second time, the transmission of a radio packet that depends upon a second anonymous address; and
disabling, between the first time and the second time, the transmission of a radio packet that depends upon either the first anonymous address or the second anonymous address.

2. A method as claimed in claim 1, wherein the mobile transceiver has a unique identity in the wireless communication network and the first anonymous address and second anonymous address are independent of that identity.

3. A method as claimed in claim 1, further comprising: randomly generating at least a portion of the first anonymous address before enabling the transmission of a radio packet that depends upon the first anonymous address and randomly generating at least a portion of the second anonymous address before enabling the transmission of a radio packet that depends upon the second anonymous address.

4. A method as claimed in claim 1, wherein the step of disabling, comprises disabling between the first time and the second time, the transmission of all radio packets that depend on either the first anonymous address or the second anonymous address.

5. A method as claimed in claim 1, wherein a radio packet depends upon an anonymous address when it includes the anonymous address.

6. A method as claimed in claim 5, wherein the anonymous address is included in a field of the packet that indicates the source of the transmitted packet.

7. A method as claimed in claim 1, wherein a transmission of a radio packet depends upon an anonymous address when it includes a synchronization word based upon the anonymous address.

8. A method as claimed in claim 1, wherein a transmission of a radio packet depends upon an anonymous address when it uses a frequency from a frequency-hopping-sequence based upon the anonymous address.

9. A method as claimed in claim 1, wherein a transmission of a radio packet depends upon an anonymous address when it is a L2CAP link establishment packet.

10. A method as claimed in claim 1, wherein the step of disabling prevents the transmission of FHS packets between the first time and the second time.

11. A method as claimed in claim 1, wherein the step of disabling prevents the mobile transceiver replying to an inquiry request between the first time and the second time.

12. A method as claimed in claim 1, wherein the step of disabling prevents the mobile transceiver replying to a page request between the first time and the second time.

13. A method as claimed in claim 1, further comprising transmitting, between the first time and the second time, radio packets that depend on neither the first anonymous address nor the second anonymous address.

14. A method as claimed in claim 1, wherein the privacy level for the mobile transceiver is dependent on the spatial location of the at least one other node with respect to the spatial location of the mobile transceiver.

15. A method as claimed in claim 1, wherein the at least one other node is arranged to perform the method as defined in claim 1.

16. A method as claimed in claim 1, wherein the privacy level of the mobile transceiver is dependent on the first time and the second time for the at least one other node with respect to the first time and the second time for the mobile transceiver.

17. A method as claimed in claim 1, wherein the first time and second time for the mobile transceiver are different from the first time and second time for the at least one other node.

18. A method as claimed in claim 1, wherein the privacy level for the mobile transceiver is the Geographical Anonymity Set (GAS) of the mobile transceiver.

19. A method as claimed in claim 1, comprising calculating the privacy level of the mobile transceiver in accordance with equations 1 to 5.

20. A method as claimed in claim 1, comprising calculating the result for equation 2 according to the pseudo code in table 3.

21. A method as claimed in claim 1, comprising calculating the privacy level of the mobile transceiver using the following: the Position Privacy Contribution (PPC), the Node Privacy Level (NPL) and the System Privacy Level (SPC).

22. A method as claimed in claim 1, comprising calculating the second time dependent on a desired privacy level for the mobile transceiver.

23. A method as claimed in claim 1, comprising calculating the second time dependent on a desired privacy level for the mobile transceiver and a desired privacy level for at least one other node with which the mobile transceiver is communicating.

24. A method as claimed in claim 1, comprising calculating the second time by the steps of:
determining the number of nodes located in an area of known size surrounding the mobile transceiver and in which the mobile transceiver is located;
assessing the contribution that each of these nodes makes to a privacy level of the mobile transceiver; and
determining a duration of a silent period for which transmission by the node of a packet depending on an anonymous address is to be disabled in dependence on the assessed contribution and a desired privacy level of the mobile transceiver.

25. A method as claimed in claim 24, further comprising the step of calculating a node density from the determined number of nodes and the area of known size.

26. A method as claimed in claim 25, wherein the step of assessing the contribution that each of the surrounding nodes makes to a privacy level of the mobile transceiver comprises estimating a relationship between the privacy level and the duration of the silent period at the calculated node density.

27. A method as claimed in claim 26, wherein the network element determines the duration of the silent period by selecting the duration that according to the relationship corresponds to a privacy level equal to the desired privacy level.

28. A network element capable of operating in a wireless communication network and of communicating with at least one node in the network, the network element being arranged to combat tracking of a wireless transceiver that forms one of the nodes by the steps of:
determining the number of nodes located in an area of known size surrounding the mobile transceiver and in which the mobile transceiver is located;
assessing the contribution that each of these nodes makes to a privacy level of the mobile transceiver; and
determining a duration of a silent period for which transmission by the node of a packet depending on an anonymous address is to be disabled in dependence on the assessed contribution and a desired privacy level of the mobile transceiver.

29. A network element as claimed in claim 28, wherein the network element is arranged to calculate a node density from the determined number of nodes and the area of known size.

30. A network element as claimed in claim 29, wherein the network element is arranged to assess the contribution that each of the surrounding nodes makes to a privacy level of the mobile transceiver by estimating a relationship between the privacy level and the duration of the silent period at the calculated node density.

31. A network element as claimed in claim 29, wherein the network element is arranged to assess the contribution that each of the surrounding nodes makes to a privacy level of the mobile transceiver by accessing a known relationship between the privacy level and the duration of the silent period at the calculated node density.

32. A network element as claimed in claim 31, wherein the network element is arranged to access the known relationship from a memory contained within the network element.

33. A network element as claimed in claim 31, wherein the network element is arranged to access the known relationship from a memory external to the network element.

34. A network element as claimed in claim 33, wherein the network element determines the duration of the silent period by selecting the duration that according to the relationship corresponds to a privacy level equal to the desired privacy level.

35. A communication system comprising at least one node, the nodes being capable of communicating with each other via the communication system, and the communication system being arranged to combat tracking of a mobile transceiver that forms one of the nodes by the steps of:
enabling, until a first time, the transmission of a radio packet that depends upon a first anonymous address;
calculating, dependent on a privacy level for the mobile transceiver, a second time;
enabling, from the second time, the transmission of a radio packet that depends upon a second anonymous address; and
disabling, between the first time and the second time, the transmission of a radio packet that depends upon either the first anonymous address or the second anonymous address.
